(19) United States
(12) Patent Application Publication
(10) Pub. No.: US 2019/0138236 A1
(43) Pub. Date: May 9, 2019

(54) System and Method to Reserve Persistent Memory Space in an NVDIMM for NVDIMM Namespace Support

(71) Applicant: DELL PRODUCTS, LP, Round Rock, TX (US)

(72) Inventors: Price Tsai, Taipei (TW); Howard Wang, New Taipei (TW); Ching-Lung Chao, Austin, TX (US)

(21) Appl. No.: 15/808,354

(22) Filed: Nov. 9, 2017

(51) Int. Cl. G06F 3/06

(52) U.S. Cl. CPC G06F 3/0631; G06F 3/068; G06F 3/0647; G06F 3/0604

(57) ABSTRACT

A non-volatile dual inline memory module (NVDIMM) includes a registered dynamic random access memory (RDRAM) having a first capacity, and a non-volatile random access memory (NVRAM) having a second capacity. The first capacity is substantially equal to the second capacity. The NVRAM is configured with a reserved memory portion at a top of a DIMM physical address space of the NVDIMM. The reserved portion includes a label storage area for establishing a plurality of namespaces on the NVRAM.

### FIELD OF THE DISCLOSURE

This disclosure generally relates to information handling systems, and more particularly relates to reserving persistent memory space in a non-volatile dual inline memory module (NVDIMM) for NVDIMM namespace support.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A non-volatile dual inline memory module (NVDIMM) may include a registered dynamic random access memory (RDRAM) having a first capacity, and a non-volatile random access memory (NVRAM) having a second capacity. The first capacity may be substantially equal to the second capacity. The RDRAM may be configured with a reserved memory portion at a top of a DIMM physical address space of the NVDIMM. The reserved portion includes a label storage area for establishing namespaces on the RDRAM.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a generalized information handling system according to an embodiment of the present disclosure;

FIG. 2 is a block diagram illustrating an information handling system according to an embodiment of the present disclosure;

FIG. 3 is a block diagram illustrating a method for mapping the DIMM address space (DPA) of NVDIMMs in a system physical address (SPA) space of the information handling system of FIG. 2;

FIG. 4 is a block diagram illustrating a usage of NVRAMs to utilize namespaces is accordance with an embodiment of the present disclosure; and

FIG. 5 illustrates a method for providing a reserved memory portion of a NVRAM on a NVDIMM according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

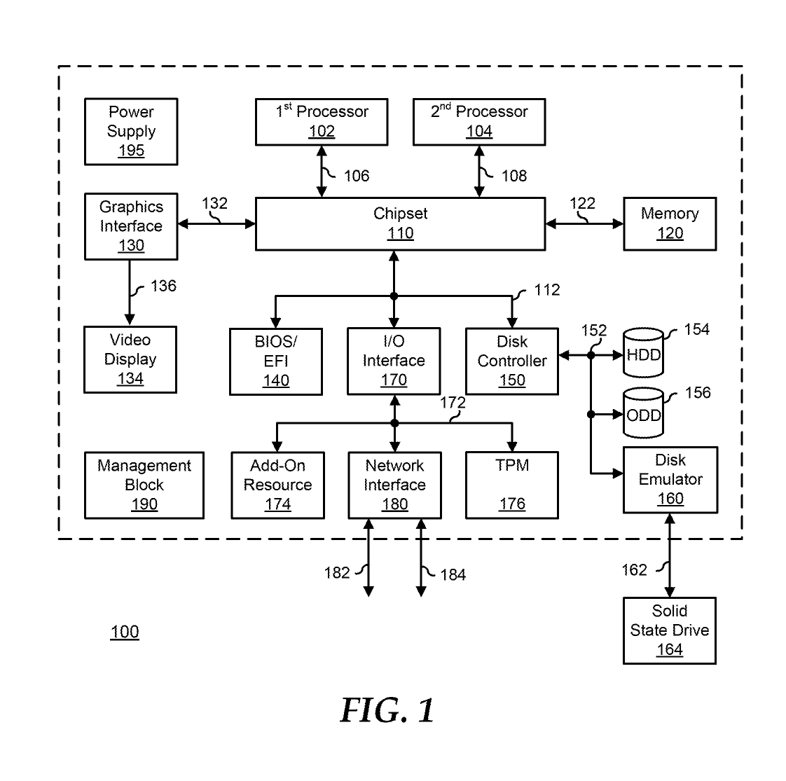

FIG. 1 illustrates a generalized embodiment of an information handling system 100. For purpose of this disclosure information handling system 100 can be configured to provide the features and to perform the functions of the OPF system as described herein. Information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described below, and operates to perform one or more of the methods described below. Information handling system 100 includes a processors 102 and 104, a chipset 110, a memory 120, a graphics interface 130, a basic input and output system/extensible firmware interface (BIOS/EFI) module 140, a disk controller 150, a hard disk drive (HDD) 154, an optical disk drive (ODD) 156, a disk emulator 160 connected to an external solid state drive (SSD) 162, an input/output (I/O) interface 170, one or more add-on resources 174, a trusted platform module (TPM) 176, a network interface 180, a management block 190, and a power supply 195. Processors 102 and 104, chipset 110, memory 120, graphics interface 130, BIOS/EFI module 140, disk controller 150, HDD 154, ODD 156 , disk emulator 160, SSD 162, I/O interface 170, add-on resources 174, TPM 176, and network interface 180 operate together to provide a host environment of information handling system 100 that operates to provide the data processing functionality of the information handling system. The host environment operates to execute machine-executable code, including platform BIOS/EFI code, device firmware, operating system code, applications, programs, and the like, to perform the data processing tasks associated with information handling system 100.

In the host environment, processor 102 is connected to chipset 110 via processor interface 106, and processor 104 is connected to the chipset via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources. BIOS/EFI module 140 includes code that operates to detect resources within information handling system 100, to provide drivers for the resources, to initialize the resources, and to access the resources.

Disk controller 150 includes a disk interface 152 that connects the disk controller to HDD 154, to ODD 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an IEEE 1394 (Firewire) interface, a proprietary interface, or a combination thereof. Alternatively, solid-state drive 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

Management block 190 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 100. In particular, management block 190 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 100, such as system cooling fans and power supplies. Management block 190 can include a network connection to an external management system, and the management block can communicate with the management system to report status information for information handling system 100, to receive BIOS/UEFI or system firmware updates, or to perform other task for managing and controlling the operation of information handling system 100. Management block 190 can operate off of a separate power plane from the components of the host environment so that the management block receives power to manage information handling system 100 when the information handling system is otherwise shut down. An example of management block 190 may include a commercially available BMC product that operates in accordance with an Intelligent Platform Management Initiative (IPMI) specification, such as a Integrated Dell Remote Access Controller (iDRAC), or the like. Management block 190 may further include associated memory devices, logic devices, security devices, or the like, as needed or desired.

Power supply 195 represents one or more devices for power distribution to the components of information handling system 100. In particular, power supply 195 can include a main power supply that receives power from an input power source, such as a wall power outlet, a power strip, a battery, or another power source, as needed or desired. Here, power source 195 operates to convert the power at a first voltage level from the input power source to one or more power rails that are utilized by the components of information handling system. Power supply 195 can also include one or more voltage regulators (VRs) that each receive power from the main power supply and that operate to convert the input voltage to an output voltage that is used by one or more components of information handling system. For example, a VR can be provided for each of processors 102 and 104, and another VR can be provided for memory 120. Power supply 195 can be configured to provide a first power plane that provides power to the host environment, and to provide a second power plane that provides power to the management environment.

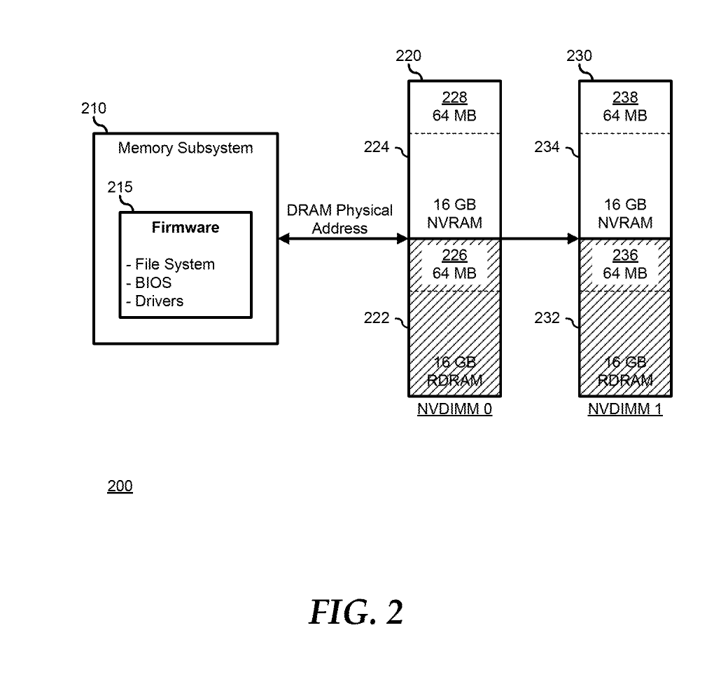

FIG. 2 illustrates an information handling system 200 similar to information handling system 100, and including a memory subsystem 210 and Non-Volatile Dual Inline Memory Modules (NVDIMMs) 220 and 230. Information handling system 200 may include a processor complex that operates to provide data processing functionality of information handling system 200, such as is typically associated with an information handling system. As such, the processor complex may represent a data processing apparatus, such as one or more central processing units (CPUs) or processor cores, and the associated data input and output I/O functionality, such as a chipset component, and other I/O processor components. The processor complex may operate to execute machine-executable code to perform the data processing tasks associated with information handling system 200.

Memory subsystem 210 represents a portion of the processor complex that is dedicated to the management of the data storage and retrieval from the memory devices of information handling system 200, and may include one or more memory controllers. As such, memory subsystem 210 may reside on a system printed circuit board, may be integrated into an I/O hub, or may be integrated with a processor on a system-on-a-chip (SoC), as needed or desired. Memory subsystem 210 operates to provide data and control interfaces to one or more DIMM, such as NVDIMMs 220 and 230, in accordance with a particular memory architecture. For example, memory subsystem 210 and NVDIMMs 220 and 230 may operate in accordance with a Double-Data Rate (DDR) standard, such as a JEDEC DDR4 or DDR5 standard.

Memory subsystem 210 includes subsystem firmware 215. Firmware 215 represents platform level BIOS, drivers, and file systems that provide for various levels of access to the functions and features of memory subsystem 210. For example, a driver portion of firmware 215 may be provided based upon a particular make, or manufacturer of one or more of NVDIMMs 220 and 230 to provide access to various functions and features of the NVDIMMs. In particular, a driver portion of firmware 215 may provide low level command access to NVDIMMs 220 and 230. For example, the driver portion may include commands for system memory read and write access to NVDIMMs 220 and 230, commands for data block access to the NVDIMMs, such as via a NVDIMM Firmware Interface Table (NFIT) driver, or other low level access commands for the NVDIMMs. The driver portion of firmware 215 may be provided based upon a particular make, or manufacturer of one or more of NVDIMMs 220 and 230 to provide access to various functions and features of the NVDIMMs. Further, the BIOS portion of firmware 215 may operate to initialize memory subsystem 210 and NVDIMMs 220 and 230 during a platform boot process, and to provide function calls that permit a platform operating system or an application to access the NVDIMMs by invoking the driver commands. For example, the driver portion may include a data block access driver, such as a NVDIMM Firmware Interface Table (NFIT) driver. Finally, the file system portion of firmware 215 may operate to provide file level access to the operating system or application by invoking the BIOS calls.

NVDIMMs 220 and 230 represent DIMM modules of the JEDEC NVDIMM-N type that each include a respective Registered Dynamic Random Access Memory (RDRAM) portion 222 and 232, and a respective Non-Volatile Random Access Memory (NVRAM) portion 224 and 234. RDRAM 222 and 232 each provide byte addressable memory regions that are mapped to the system physical address space, as may found on RDRAM-only DIMMs. NVRAM 224 and 234 each provide memory regions that are invisible in the system physical address space, but are available in the case where the NVRAMM provided for a power-fail backup to the contents stored in respective RDRAMM 222 and 232. As such, information handling system 200 includes a separate power supply from a system power supply to NVDIMMs 220 and 230 to power the NVDIMMs to permit data transfers when the system power supply fails. The separate power supply may include a battery, a super-capacitor, or another power supply as needed or desired. The particulars of the power-fail backup process are beyond the scope of the present disclosure, and will not be further discussed herein except as needed to describe the present embodiments. RDRAM 222 is illustrated as including a reserved memory portion 226 and NVRAM 224 is illustrated as including a reserved memory portion 228. Similarly, RDRAM 232 is illustrated as including a reserved memory portion 236 and NVRAM 234 is illustrated as including a reserved memory portion 238. Reserved memory portions 226, 228, 236, and 238 will be discussed more fully below.

Generally, for NVDIMM-N type NVDIMMs such as NVDIMMs 220 and 230, the storage capacity of RDRAMs 222 and 232 are substantially equal to the storage capacity of respective NRAMs 224 and 234. For the purpose of illustration, each of RDRAMs 222 and 232 and NVRAMs 224 and 234 will be assumed to provide 16 Gigabytes (GB) of power-fail backup.

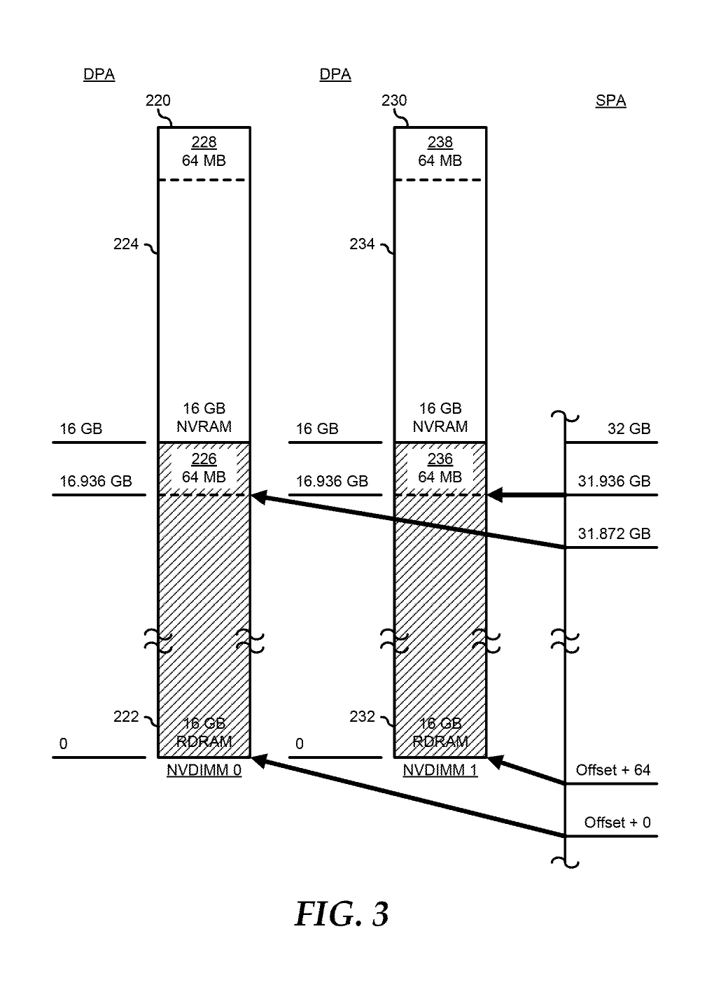

FIG. 3 illustrates a method for mapping the DIMM address space (DPA) of NVDIMMs 220 and 230 in the system physical address (SPA) space of information handling system 200. The DPA for NVDIMM 220 is mapped such that the 16 GB of RDRAM 222 is addressed at the bottom of the DPA, starting at a zero address byte (00000h) and ending at the 16 GB border (0FFFFh). Reserved memory portion 226 is mapped at the top 64 MB of NVRAM 222, starting at the 16.936 GB border and ending at the 16 GB border. Similarly, the DPA for NVDIMM 230 is mapped such that the 16 GB of RDRAM 232 is addressed at the bottom of the DPA, starting at a zero address byte (00000h) and ending at the 16 GB border (0FFFFh). Reserved memory portion 236 is mapped at the top 64 MB of RDRAM 232, starting at the 15.936 GB border and ending at the 16 GB border.

Here, the architecture of information handling system 200 is provided such that NVDIMMs 220 and 230 are two-way interleaved into the SPA, such that together, they are mapped to 32 GB of the SPA. The two-way interleaving is provided based upon a configuration of a memory controller of memory subsystem 210. In particular, the memory controller may be configured to provide the two-way interleaving, or may be configured to provide direct, that is, one-way, interleaving. In a particular embodiment, memory subsystem may be configurable to provide other interleavings, such as four-way interleaving that maps four DIMMs into the SPA of information handling system 200, or other interleavings, as needed or desired. In the illustrated two-way interleaving, NVDIMMs 220 and 230 are mapped to a particular offset address within the SPA, such that a memory access to the offset address is addressed to the bottom zero address byte of NVDIMM 220. Here, it will be understood that NVDIMMs 220 and 230 are each configured to handle a minimum number of bytes of data in each memory transaction. For example, NVDIMMs 220 and 230 may provide 64 bits of data and have a minimum burst length of 8 transactions, such that the minimum addressable chunk is 64 bytes. In this regard, a memory access to the next addressable chunk in the SPA, that is to “Offset+64,” is addressed to the bottom zero address byte of NVDIMM 230. Similarly, a memory access to the 32 GB border in the SPA is addressed to the 16 GB border of NVDIMM 220, and a memory access to a next addressable chunk in the SPA, that is to “Offset+32 GB+64,” is addressed to the 16 GB border of NVDIMM 230. Further, reserved memory portions 226 and 236. Note that the illustration of NVDIMMs 220 and 230 as being interleaved is for the illustrative purposes, and the skilled artisan would understand that the teachings as described herein may be equally applied when the NVDIMMs are not interleaved.

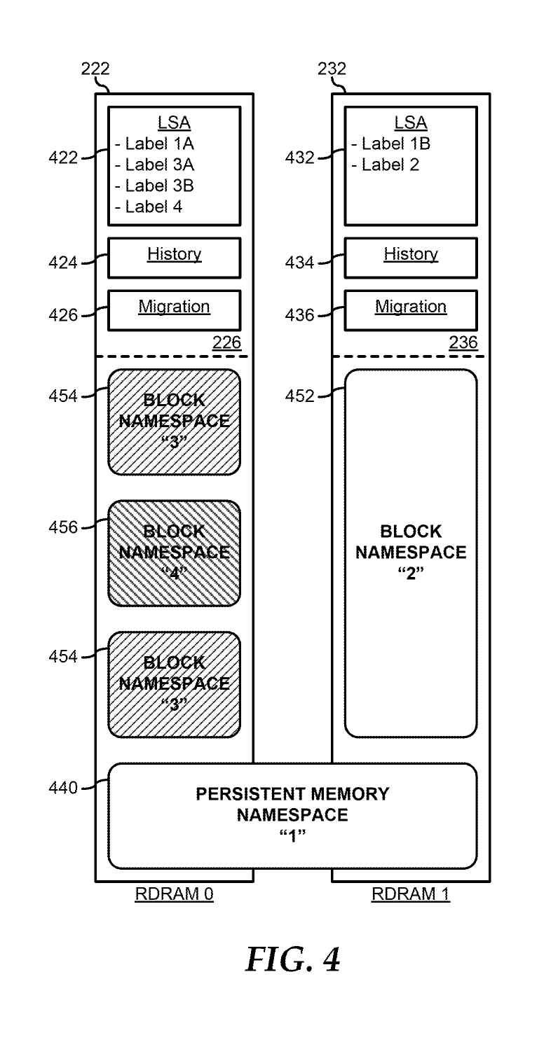

FIG. 4 illustrates an example usage of an embodiment of RDRAMs 222 and 232, where NVDIMMs 220 and 230 operate to utilize namespaces in accordance with a NVDIMM Namespace Specification, such as the NVDIMM Namespace Specification, Revision 1.0, Apr., 2015. Here, NVDIMMs 220 and 230 operate to provide a mechanism for subdividing respective RDRAMs 222 and 232 into logical units called “namespaces.” In this regard, NVRAM 222 and 232 are accessible via byte-addressable memory transactions that map the SPA to the DPA in a particular x-way interleaved mapping, as described above, and the NVRAMs are accessible via block transactions, such as the Block Window (BW) access mechanism. In this regard, information handling system 200 may implement a variety of different mappings in different portions of NVDIMMs 220 and 230. In particular, different portions of RDRAMS 222 and 232 may be accessed as x-way interleaved memory space via a Persistent Memory Namespace (PMN), or via a Block Mode Namespace (BMN).

In the illustrated example, RDRAMs 222 and 232 are configured to implement a PMN 440 that is two-way interleaved across the RDRAMs. Note that PMN 440 is located at the bottom of RDRAMs 224 and 234. In a particular embodiment, any and all PMNs implemented on the NVRAMs of one or more NVDIMMs must be located at the bottom of the DPA of the respective NVRAMs. The definition of PMN 440 is provided by one or more labels provided in a label storage area (LSA) 422 and a LSA 432 in reserved memory portions 226 and 236, as described further below. Multiple PMNs may be defined in NVRAMs 224 and 234, and the additional PMNs may be x-way interleaved, as needed or desire. NVRAMs 224 and 234 are further configured to implement BMN 452 in NVRAM 234, and BMNs 454 and 456 in NVRAM 234. In a particular embodiment, any and all BMNs implanted on the NVRAMs of one or more NVDIMMs must be located in the DPA of the respective NVRAMs above any PMNs that are implemented on the NVRAMs. The definition of BMNs 452, 454, and 456 are provided by one or more labels provided in LSAs 422 and 432 as described further below. Note that BMN 454 is not in contiguous locations in the DPA space.

As illustrated, reserved memory portion 226 stores LSA 422, history information 424, and migration information 426, and reserved memory portion 236 stores LSA 432, history information 434, and migration information 436. LSA 422 includes a label for the portion of PMN 440 that is in the DPA of NVRAM 224, and LSA 432 includes a label for the portion of PMN 440 that is in NVRAM 234. Similarly, any PMN that is interleaved across more than one NVRAM will include a label in the respective LSA that is associated with the portion of the PMN in the NVRAM. LSA 422 further includes two labels for BMN 454 and another label for BMN 456. Note that where a BMN is not contiguous in the DPA of a particular NVRAM will have a separate label for each discontiguous portion of the DPA that the BMN occupies. LSA 432 further includes a label for BMN 452.

In a particular embodiment, LSAs 422 and 432 include one or more index blocks that permit a power-fail update mechanism for tracking label validity. Further, each label identifies the associated namespace, a starting location within the DPA space, a size of the namespace, and whether the associated namespace is a PMN or a BMN. In a particular embodiment, LSAs 422 and 432 are at least 128 kilobytes (kB) in size.

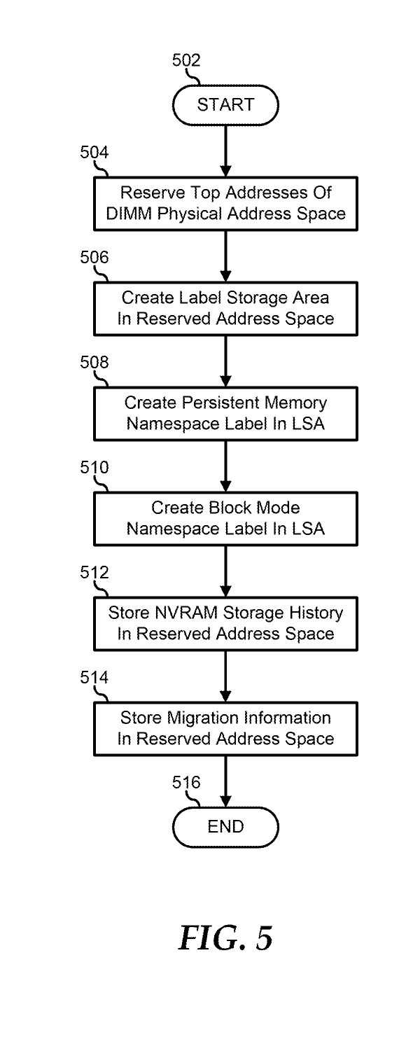

FIG. 5 illustrates a method for providing a reserved memory portion of a NVRAM on a NVDIMM, starting at block 502. A portion at the top of a DPA of a NVRAM on a NVDIMM is reserved at block 504. For example, reserved memory portion 226 can be reserved at the top of the DPA of NVDIMM 220 for LSA 422, for history information 424, and for migration information 426. A LSA is created in the reserved memory portion of the NVRAM at block 506. A PMN is created in the NVRAM in block 508. For example a label for PMN 440 can be created in both of LSAs 422 and 432. A BMN is created in the NVRAM at block 510. For example, a label for BMN 452 can be created in LSA 432. NVRAM storage history is stored in the reserved memory portion at block 512. For example, history information 424 can be stored in reserved memory portion 226. Migration information is stored in the reserved memory portion at block 514 and the method ends at block 516. For example, migration information 426 can be stored in reserved memory portion 226.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A Non-Volatile Dual Inline Memory Module (NVDIMM), comprising:
a registered dynamic random access memory (RDRAM) having a first capacity; and
a non-volatile random access memory (NVRAM) having a second capacity, the first capacity being substantially equal to the second capacity, wherein the RDRAM is configured with a reserved memory portion at a top of a DIMM physical address space of the NVDIMM, the reserved portion including a label storage area for establishing a plurality of namespaces on the RDRAM.

2. The NVDIMM of claim 1, the reserve portion further including block usage history for memory storage blocks of the RDRAM.

3. The NVDIMM of claim 1, the reserve portion further including migration information for the RDRAM.

4. The NVDIMM of claim 1, wherein the reserved memory portion is 64 gigabytes.

5. The NVDIMM of claim 4, wherein the label storage area is 128 kilobytes.

6. The NVDIMM of claim 1, wherein the label storage area includes a first label for a permanent memory namespace.

7. The NVDIMM of claim 6, wherein the label storage area includes a second label for a block mode namespace.

8. The NVDIMM of claim 1, wherein the NVDIMM is an NVDIMM-N type NVDIMM.

9. A method, comprising:
providing, on a Non-Volatile Dual Inline Memory Module (NVDIMM), a registered dynamic random access memory (RDRAM) having a first capacity;
providing, on the NVDIMM, a non-volatile random access memory (NVRAM) having a second capacity, the first capacity being substantially equal to the second capacity;
reserving, at a top of a DIMM physical address space of the RDRAM, a reserved memory portion of the NVDIMM, the reserved portion; and
including, in the reserved memory portion, a label storage area for establishing a plurality of namespaces on the RDRAM.

10. The method of claim 9, further comprising:
including, in the reserved memory portion, block usage history for memory storage blocks of the RDRAM.

11. The method of claim 9, further comprising:
including, in the reserved memory portion, migration information for the RDRAM.

12. The method of claim 9, wherein the reserved memory portion is 64 gigabytes.

13. The method of claim 12, wherein the label storage area is 128 kilobytes.

14. The method of claim 9, further comprising:
including, in the label storage area, a first label for a permanent memory namespace.

15. The method of claim 14, further comprising:
including, in the label storage area, a second label for a block mode namespace.

16. The method of claim 9, wherein the NVDIMM is an NVDIMM-N type NVDIMM.

17. An information handling system, comprising:
a memory controller; and
a Non-Volatile Dual Inline Memory Module (NVDIMM) including:
a registered dynamic random access memory (RDRAM) having a first capacity; and
a non-volatile random access memory (NVRAM) having a second capacity, the first capacity being substantially equal to the second capacity;
wherein the memory controller configures the RDRAM with a reserved memory portion at a top of a DIMM physical address space of the NVDIMM, the reserved portion including a label storage area for establishing a plurality of namespaces on the RDRAM.

18. The information handling system of claim 17, the reserve portion further including block usage history for memory storage blocks of the RDRAM.

19. The information handling system of claim 17, the reserve portion further including migration information for the RDRAM.

20. The information handling system of claim 17, wherein the reserved memory portion is 64 gigabytes, and the label storage area is 128 kilobytes.
